(19) United States
(12) Patent Application Publication
(10) Pub. No.: US 2021/0136539 A1
(43) Pub. Date: May 6, 2021

(54) LPWAN BASED LAND SECURITY SYSTEM

(71) Applicant: Muhammet Talha BUYUKAKKASLAR, Istanbul (TR)

(72) Inventor: Muhammet Talha BUYUKAKKASLAR, Istanbul (TR)

(21) Appl. No.: 16/605,042

(22) PCT Filed: Oct. 25, 2017
(86) PCT No.: PCT/TR2017/000111

§ 371 Date: Oct. 14, 2019

(30) Foreign Application Priority Data
Apr. 13, 2017 (TR) 2017/05549

(51) Int. Cl. H04W 4/38; G06F 21/88; H04L 29/06; H04W 12/126; H04L 29/08; H04W 4/90; H04W 4/02; H04W 4/021

(52) U.S. Cl. CPC H04W 4/38; G06F 21/88; H04L 63/1441; H04W 12/126; H04W 84/04; H04W 4/90; H04W 4/023; H04W 4/022; G06F 2221/2111; H04L 67/12

(57) ABSTRACT

An LPWAN based land security system is a smart stone security system including GPS sensors, a flash memory for keeping the software and necessary records, a processor for digitally processing the data of all incoming sensors, a power supply and motion sensor that can detect movement and that can communicate with the selected frequencies required for RF signal applications.

### CROSS REFERENCE TO THE RELATED APPLICATIONS

This application is the national phase of International Application No. PCT/TR2017/000111, filed on Oct. 25, 2017, which is based upon and claims priority to Turkish Patent Application No. 2017/05549, filed on Apr. 13, 2017, the entire contents of which are incorporated herein by reference.

### TECHNICAL FIELD

The present invention is related to a LPWAN based land security system that is used in any kind of open areas that any unauthorized passage (human-animal) is required to be identified and prevented from entering any kind of open areas that are under military protection (patrol zones, military crossing areas, etc.), in border areas, in factory areas, in special areas such as university campuses, in fields and fruit gardens, and that is capable of communicating in the required frequencies and that is comprised of hardware to detect motion.

### BACKGROUND

The technical disadvantages encountered in the applications in the state of the art are as follows:
MESH topology is used. Therefore, it is weak in terms of energy and security. Before the attack, enemy elements infiltrate the outposts of the station and approach the outposts of the station. In the borders, terrorists and smugglers make unauthorized transits by taking advantage of the mountainous terrain. Malicious people can steal and sabotage by infiltrating the factory environments. Also, damage to crops can occur by the entry of wild animals such as pigs in fields and fruit gardens.
ACK message is not used. Therefore, the message transmission cannot be confirmed.
Since there is no ACK, there is no mechanism to increase the interference durability by sending a stronger signal in case of ACK.
It relies on expensive sensors like cameras or only PIR sensors that cannot differentiate.
Mesh topology will not be able to transmit messages even if the end node is working and the intermediate nodes disappear. For this reason, it depends on the installation structure. For this reason, it cannot be used in city conflicts. In city conflicts walls, barrier obstacles limiting horizontal observation, the number of UAVs and area focusing problems, as well as weather and weather conditions, can limit the possibility of observing from the air. In addition, when underground tunnels are opened and there is no possibility of observing them, an instant response is not possible.
The combination of the synchronous mac layer and the sleep mechanism can cause messages to be delayed. Instant intelligence is limited. The messages are delayed to the center depending on various parameters. This process can take minutes.
Since the signal range is short, it is possible to steal it if the sensors are moved and disconnected from the network.
A software update cannot be done at all or is very difficult because it will cause too much load on the entire network.

### SUMMARY

The present invention relates to a LPWAN based land security system developed to remove the above-mentioned disadvantages and bring new advantages to the related art.

The inventive LPWAN-based land security system is an intelligent stone security system that can detect and communicate with the necessary frequencies.

The advantages of the present invention are summarized as follows:
Provides the ability to update the software when necessary.
Real-time response.
Provides more efficient battery use.
A more durable model to interference (interference-jammer)
ACK allows you to be sure that the message has been transmitted. If the ACK message is not received, it is a stronger mechanism against a possible jamming attack by sending a stronger signal.
With a signal range of 10-40 km, the sensor can ask for help by sending a text message. Until security units find it, it is able to send its location for as long as it can. Due to the maximum range of 20-50 km, even if people try to pick up and steal the sensor, it can ask for help by sending its location signal until security units' reach it.
Due to the star of all the star topology, it can be used in city conflicts.
The asynchronous mac layer provides instant intelligence.
It does not require the use of expensive sensors such as cameras etc.
Movements of enemies can be followed in urban conflicts by leaving them in urban areas, (due to the star of the all star topology, the system is active if only one is active).
Software upgrades can be made later to the nodes that are left at various sites.
Operators to connect to the system can take action without any intervention, (embedded bomb, Built-in Projector, Automatic moving UAV, audio device, Cameras).

### BRIEF DESCRITION OF THE DRAWINGS

The following figures should be considered schematically in themselves with the reference numbers one by one.

FIG. 1 shows the node unit is schematically shown in the inventive LPWAN based land security system.

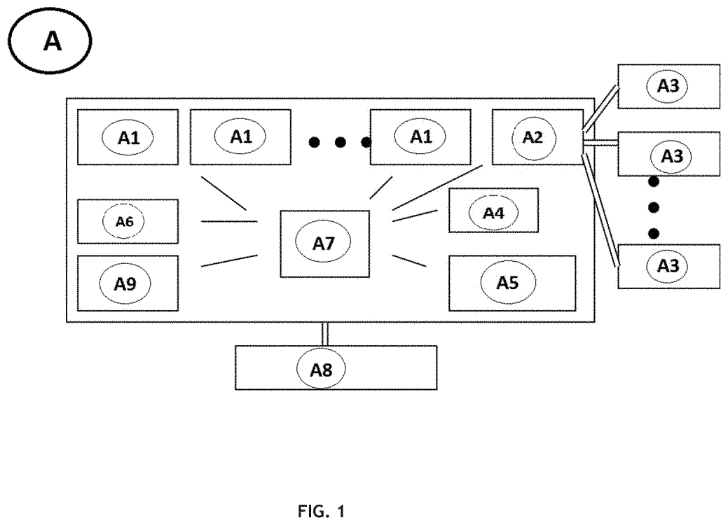

FIG. 2 shows the LPWAN-based land security system of the present invention is shown schematically around a police station.

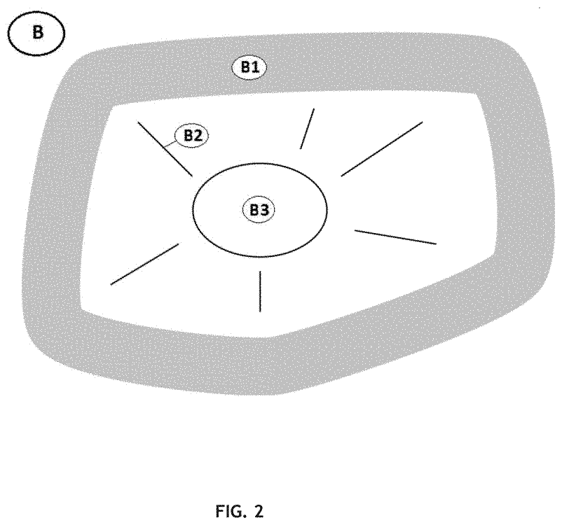

FIG. 3 shows the LPWAN-based land security system of the present invention is schematically illustrated in an internal location.

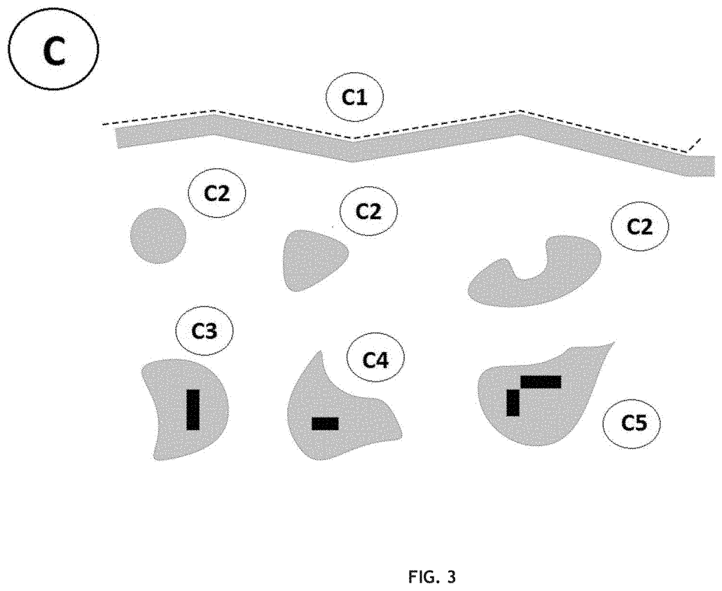

FIG. 4 shows the LPWAN-based land security system of the present invention is illustrated schematically in a city conflict.

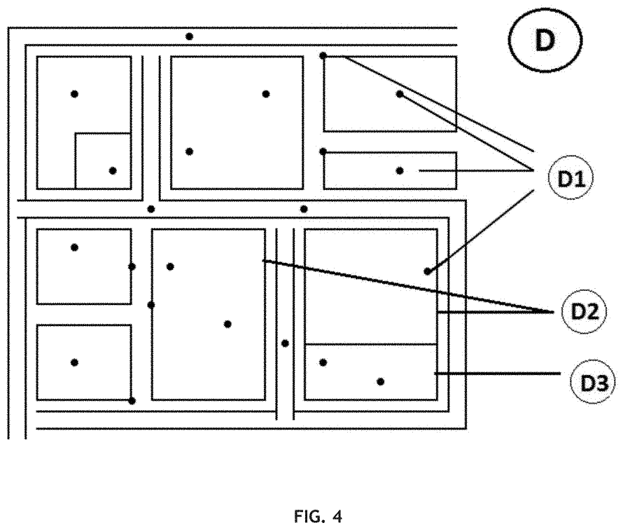

FIG. 5 shows the network topology of the LPWAN based land security system is illustrated schematically.

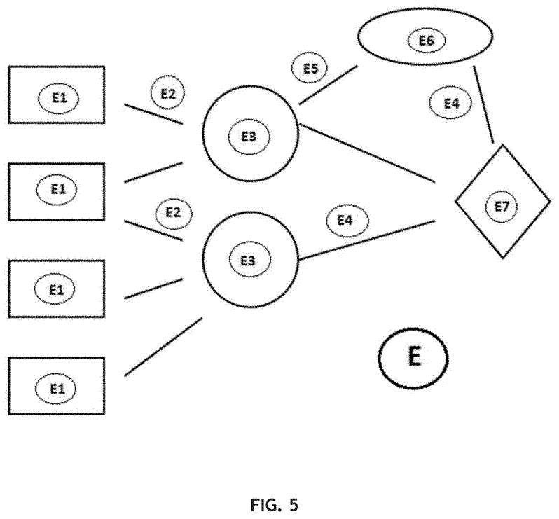

### REFERANCE NUMBER ACCORDING TO THE APPLICATION AREAS TO HELP DISLOSURE OF THE INVENTION

A. Node Unit

A1. Sensors

A2. External hardware interface

A3. External hardware

A4. Flash memory

A5. RF communication unit

A6. Motion sensor

A7. Processor

A8. Power supply or battery unit

A9. GPS sensor

B. Layout around the police station

B1. Sensor Line

B2. Safe Distance

B3. Station

C. Inland settlement

C1 . Linear layout

C2. Critical Internal Regions

C3. Station

C4. Important buildings

C5. Enemy Expected locations

D. City Conflict

D1 . Nodes

D2. Buildings

D3. Gardens

E. Network Topology

E1. Node Sensor

E2. RF Communication

E3. Gateway-Base Station

E4. Local Traditional internet or intranet

E5. Local network

E6. Local server

E7. Central server

### DETAILED DESCRIPTION OF THE EMBODIMENTS

The inventive LPWAN based land security system is a smart stone security system developed with a GPS sensor, a flash memory, a processor, a power supply and a motion sensor that can detect movement and can communicate with the selected frequencies required for the RF signal application. The LPWAN based land security system of the invention provides a solution to the intelligent stone security system by the following methods;
Due to the star of the all star topology, it can be used in city conflicts.
The asynchronous mac layer provides instant intelligence.
It does not require the use of expensive sensors such as cameras, etc.
ACK allows you to be sure that the message has been transmitted.
If the ACK message is not received, it is a stronger mechanism against a possible jamming attack by sending a stronger Signal.
Due to the maximum range of 20-50 km, even if people try to pick up and steal the sensor, it can ask for help by sending its location signal until security units' reach it.
Movements of enemies can be followed in urban conflicts by leaving them in urban areas, (due to the star of the all star topology, the system is active if only one is active).
Software upgrades can be made later to the nodes that are left at various sites.
Operators to connect to the system can take action without any intervention, (embedded bomb, Built-in Projector, Automatic moving UAV, audio device, Cameras).

A. Node Unit

A1. Sensors: PIR, ultrasonic, etc. there may be various sensors.

A2. External hardware interface: Required external communication unit.

A3. External hardware: Optional external units that can be added.

A4. Flash memory: The flash memory on which the software and necessary records are stored.

A5. RF communication unit: It is the unit that can communicate between O-infinite km, preferably as −50 km RF signal with the necessary frequencies for the application.

A6. Motion Sensor: A sensor, accelerometer and theft alarm will be used to detect when the node is moving.

A7. Processor: The unit that digitally processes the data of all incoming sensors.

A8. Power Supply: Power supply or battery.

A9. GPS Sensor: GPS receiver to be used to know the position of the nodes.

B. Layout around the police station

B1. Sensor line: A sensor line is set up to be 30-100 meters in depth to detect the enemy elements passing through it.

B2. Safe distance: Providing advance notice by putting a distance in accordance with the military standards with the protected area.

B.3. Station: This could be another building to protect. It represents the area that needs to be protected.

C. Inland settlement

C1. Border line layout: The sensor nodes are randomly dispersed at a distance of about 30 to 500 meters along the boundary lines, forming an electronic wall.

C2. Critical internal areas: In areas considered as important for passing or observing enemy elements, are inspected by sensors so that they do not perform malicious activities even in the case of infiltration with other methods (legal customs pass, or internal person's betrayal).

C3. Stations: A sensor system is installed at a distance to ensure the safety of the conflict area for the possible attacks to be prevented.

C4. Major Buildings: They are used around important and aggressive buildings such as industrial facilities, courthouses, etc.

C5. Places where enemies are anticipated: The areas that enemy elements can use, such as empty caves, warehouses and open spaces, are equipped with sensors only, without destroying the areas and a trap is established for these elements.

D. City Conflict

D1. Nodes: They are thrown from the air and delivered to the points in the city such as gardens between buildings.

D2. Buildings: It can be found as an obstacle to direct observation.

D3. Garden: It is a structure that can generate a warning before a possible attack and direct it to the UAV, in case of a movement inside them.

E. Network Topology

E1. Node Sensor: Detects people or animals nearby. Here, if an animal or human is said to produce a warning, it will produce or not produce a warning accordingly.

In case of producing a warning, if the RFID module is added, it generates a warning with RFID by receiving the RFID of the nearby person, or in case the RFID is not received, with the information that it has not been received.

E2. RF Communication: Alerts are preset with ACK or without ACK. The warning can also be repeated using more power or changing the frequency if the ACK is not received. The number of repetitions is preset between 0 and infinity. The range of RF communication can range from 0 to infinite kilometers, preferably from 5 to 50 km, in open areas. The ISM may be communicated over a military or licensed band-interval, depending on the type of application being performed.

E3. Gateway-Base Station: This station can be found on a blimp or UAV on a land vehicle, or a fixed wing aircraft. It constantly listens on the selected frequency and feature. It communicates with the central server via traditional communication methods. It also sends the same messages here if it is requested to send a signal to the local secondary servers. (Important to keep the sensors active by sending a signal to the police server even if the general communication in one way or another is lost.)

E4. Local Traditional internet or intranet: This part will be used to provide communication between the central server and all gateways via traditional internet methods (GPRS, Cable, ADSL, Fiber, 4G), or an intranet solution depending on the application of the selected application.

E5. Local network: Establish a stronger local communication network so that sensors can function even when the central communication is interrupted by local communication at the time of an attack.

E6. Local server: This is a local backup server where local elements can use the existing sensor network if the enemy elements block the Local Traditional internet or intranet communication in the area under attack. (There is a gateway +server in the station, normally the center is used as long as the central communication is not interrupted, but the local server and gateway are used at the time of the siege). If the central server cannot be reached, it can perform all its functions at the local level.

E7. Central server: the messages to be received from all the gateways are resolved and warnings are generated, and the actions to be taken are determined here. Then the required action is again handed to the operator through the gateway (UAV auto-launch, automatic launch of the relevant projector, camera orientation, bomb detonation).

In this connection, Sensor fusion algorithms can be developed to make the received data more meaningful (human number, animal sex-number separation) and lower unit costs with cheaper sensors.

The inventive LPWAN based land security system has been modified to include different sensors;
For measuring air quality in mines,
Leakage control in piped areas such as water, oil, or sewage
To prevent unauthorized transitions of i.e. refugees who come to the shores with acoustic sensors.
Measuring moisture, soil quality in fields
It can be mounted to control wildlife in forest areas.

What is claimed is:

1. An LPWAN-based land security system, comprising: a node unit a plurality of sensors, an external hardware interface, an external hardware, a flash memory for storing a software and necessary records, an RF communication unit providing communication in required frequencies for application by an RF signal between 0-50 km, a motion detector for detecting a movement of nodes a processor for digitally processing data of the plurality of sensors, a power supply or battery unit, a GPS sensor for determining a location of the nodes.

2. The LPWAN based land security system according to claim 1, further comprising:
an asynchronous mac layer to provide an instant intelligence; wherein, the LPWAN based land security system uses star topology or star of the stars topology;
wherein, the LPWAN based land security system is configured to generate an ACK message to indicate transmission of a message.

3. (canceled)

4. The LPWAN based land security system according to claim 1, further comprising: a sensor line to detect the enemy elements passing through an the area surrounding the outpost, wherein, the area has a depth of 30-100 meters.

5. The LPWAN based land security system according to claim 1, wherein, the plurality of sensors are randomly dispersed at a distance of about 30 to 1000 meters along a boundary line, wherein the boundary line is an electronic wall, and is used to detect presence of the plurality of sensors to prevent the plurality of sensors from engaging in malicious activities even in a case of infiltration to inner regions by inspecting and establishing a sensor system in a distance to ensure a confrontation security around the outpost, important buildings, and providing a trap for the elements that are expected to arrive.

6. (canceled)

7. The LPWAN based land security system according to claim 1, further comprising: a node sensor for detecting people or animals nearby and is configured to receive an RFID of the people and generate a warning when the RFID is not received; an RF communication: in case of alerts with the ACK message or without ACK message, wherein, the warning is repeated using more power or changing the frequency if the ACK message is not received, wherein, the RF communication uses an ISM (industrial scientific medical) band, a designated military band or a licensed RF band; a gateway-base station for constantly listening on a selected frequency is configured to communicate with a central server and also sending a signal to station servers; a local traditional internet or intranet to provide communication between the central server and all gateways via traditional internet methods; a local network: establishing a stronger local communication network so that the plurality of sensors function even when the central communication is interrupted by local communication at a time of an attack; a local server as a local backup server where local elements use the existing sensor network if the enemy elements block the local traditional internet or intranet communication during attack; the central server is configured to resolve messages to be received from all the gateways and generating warnings and determining actions, then communicating a required action to an operator through the gateways.

8. (canceled)

9. The LPWAN based land security system according to claim 2, further comprising a reinforced ACK mechanism; wherein, when the ACK message is not received, the reinforced ACK mechanism is configured to repeat the ACK message with a strong signal.
